(19) United States
(12) Patent Application Publication
(10) Pub. No.: US 2003/0130858 A1
(43) Pub. Date: Jul. 10, 2003

(54) Filtered shopping cart

(76) Inventors: Clifford A. Pickover, Yorktown Heights, NY (US); William Grey, Millwood, NY (US); Paul A. Moskowitz, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 10/041,128

(22) Filed: Jan. 7, 2002

(51) Int. Cl. G06F 17/60

(52) U.S. Cl. 705/1; 705/26

(57) ABSTRACT

A system to receive an instruction to associate an item with an electronic shopping cart, and, in response to the instruction, to determine that the item is not allowed to be associated with the electronic shopping cart. In other aspects, an instruction is issued to associate an item with an electronic shopping cart, and, in response to the instruction, an indication is received that the item is not allowed to be associated with the electronic shopping cart. By virtue of each of these aspects, embodiments of the invention provide efficient control over consumer purchases without completely preventing a consumer from purchasing items from an online store.

### BACKGROUND OF THE INVENTION

1. Field of the Invention

The present invention relates to electronic shopping. Specifically, the present invention concerns electronic shopping systems utilizing electronic shopping carts.

2. Description of the Related Art

Vast public networks such as the World Wide Web provide consumers with unprecedented freedoms. For example, these networks allow consumers to access and receive information from websites maintained by all manner of public and private institutions as well as by individuals. Consumers may also easily communicate with other individuals all over the world through e-mail and chat rooms, and purchase almost any type of good or service from online stores.

Due to this freedom, a consumer may receive information or purchase an item that is somehow inappropriate for that consumer. Specifically, a child may access mature or violent material, a consumer may purchase items in excess of the consumer's monthly budget, or a felon may receive firearms and explosives. Of course, other inappropriate scenarios also exist.

Current safeguards are able to prevent access to inappropriate websites. These safeguards mainly consist of software packages that prevent a Web browser from accessing particular websites. The particular websites are determined based on instructions received from a controlling entity, usually a parent or an employer. However, if the controlling entity wishes to prevent a consumer from purchasing an item from an online store, the entity must prevent all access to the online store.

In view of the foregoing, what is needed is a system to provide efficient and flexible control over a consumer's purchases from an online store.

### SUMMARY OF THE INVENTION

In order to address the foregoing, the present invention provides a method, an apparatus, a system, a medium, and means to receive an instruction to associate an item with an electronic shopping cart, and, in response to the instruction, to determine that the item is not allowed to be associated with the electronic shopping cart. In other aspects, an instruction is issued to associate an item with an electronic shopping cart, and, in response to the instruction, an indication is received that the item is not allowed to be associated with the electronic shopping cart. By virtue of each of these aspects, embodiments of the invention provide efficient control over consumer purchases without completely preventing a consumer from purchasing items from an online store.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to provide an electronic shopping filter according to embodiments of the present invention.

FIG. 2 is a topographic view of a network architecture according to embodiments of the present invention.

FIG. 3 is a block diagram of an internal architecture of a store server according to embodiments to the present invention.

FIG. 4 is a block diagram of an internal architecture of a consumer device according to embodiments to the present invention.

FIG. 5 is a block diagram of an internal architecture of a control device according to embodiments to the present invention.

FIG. 6 is a representative view of a tabular portion of an item database according to embodiments of the present invention.

FIG. 7 is a representative view of a tabular portion of a rules database according to embodiments of the present invention.

FIG. 8 is a representative view of a tabular portion of a consumer database according to embodiments of the present invention.

FIG. 9 is a representative view of a tabular portion of a shopping cart database according to embodiments of the present invention.

FIGS. 10A and 10B comprise a flow diagram of process steps to provide an electronic shopping filter according to embodiments of the present invention.

FIG. 11 is a representative view of a display presenting data according to embodiments of the present invention.

FIG. 12 is a representative view of a display presenting data according to embodiments of the present invention.

FIG. 13 is a representative view of a display presenting data according to embodiments of the present invention.

FIG. 14 is a representative view of a display presenting data according to embodiments of the present invention.

FIG. 15 is a representative view of a display presenting data according to embodiments of the present invention.

### DETAILED DESCRIPTION

As further background, a typical online store consists of a website that provides Web pages to a consumer. The website is operated by a merchant or by an entity that the merchant has employed for this purpose, and the Web pages present descriptions, pictures and prices of items for sale. The Web pages are organized hierarchically according to item type, and are browsed by selecting hyperlinks included therein. Once a consumer identifies an item for purchase, the consumer inputs a command to add the item to his “shopping cart”. This shopping cart is roughly an electronic counterpart to a conventional shopping cart, in that a consumer associates items with the electronic shopping cart and proceeds to “checkout”, where the items associated with the electronic shopping cart are purchased. Once a particular item is associated with an electronic shopping cart, it must be disassociated with the cart in order to purchase other items in the cart without also purchasing the particular item.

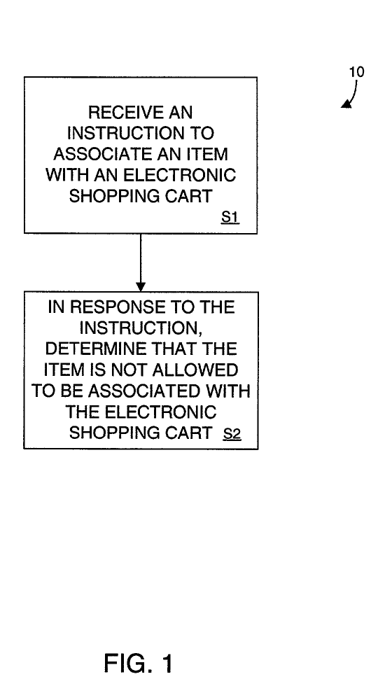

FIG. 1 is a flow diagram of process steps 10 to provide an electronic shopping filter according to some embodiments of the present invention. In order to provide an immediate introduction to features of the present invention, process steps 10 will be generally described with reference to one particular embodiment. Of course, complete descriptions of other specific hardware and software embodiments of the claimed invention are set forth below.

In the particular embodiment, a consumer operates a Web browser so as to select a video game displayed on a Web page of an online store. In response, a second Web page is transmitted to the consumer. The second Web page includes details concerning the video game, such as a description (“The Beast”), a violence rating (“7”), and a price (“$39.99”). The second Web page also includes an icon labeled “Add to Cart”. The consumer then operates the Web browser so as to select the icon. The selection of the icon is considered an instruction to associate the item with an electronic shopping cart.

Next, at step S1 of process steps 10, the instruction to associate the item with an electronic shopping cart is received. In response to the instruction, it is determined that the item is not allowed to be associated with the shopping cart in step S2. According to the present example, the determination is based on a rule defined by the consumer's guardian indicating that the particular consumer may not purchase any video games having a violence rating of 5 or greater. An indication of the determination is thereafter transmitted to the consumer, and the item is not associated with an electronic shopping cart that is associated with the consumer.

Process steps 10 thereby provide an efficient system for preventing the purchase of particular items. As mentioned above, more specific features of the invention as well as particular advantages of those features are set forth below.

Network Architecture

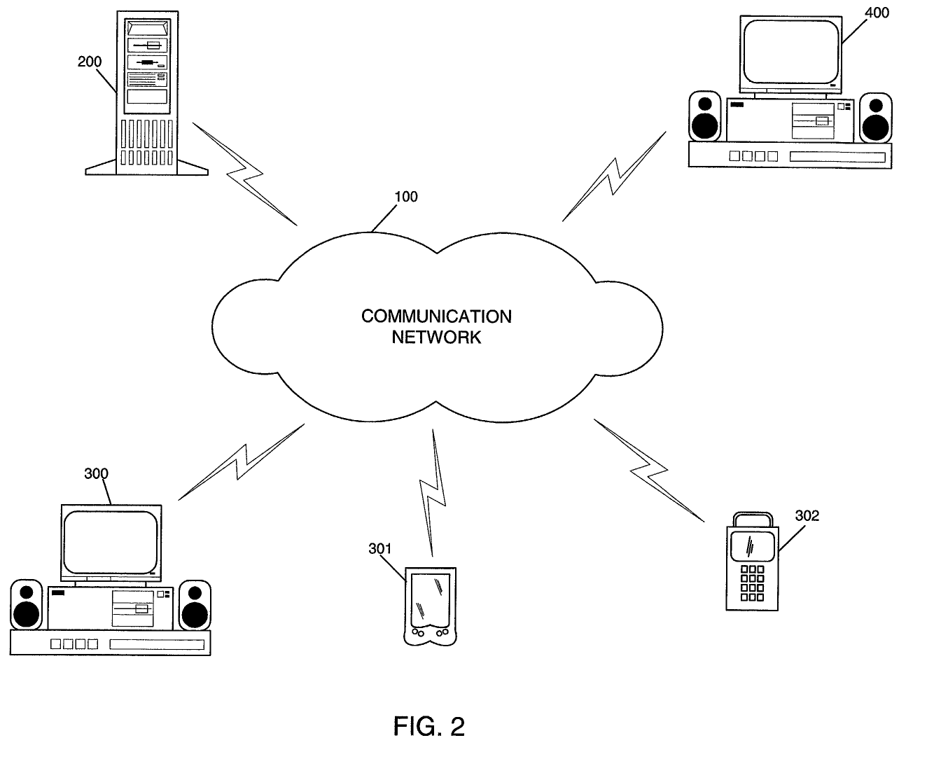

FIG. 2 is a topographic view of a network architecture according to embodiments of the present invention. Of course, network architectures other that that shown in FIG. 2 may be used to implement the invention.

FIG. 2 shows communication network 100 in communication with store server 200, consumer devices 300 to 302 and control device 400. Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

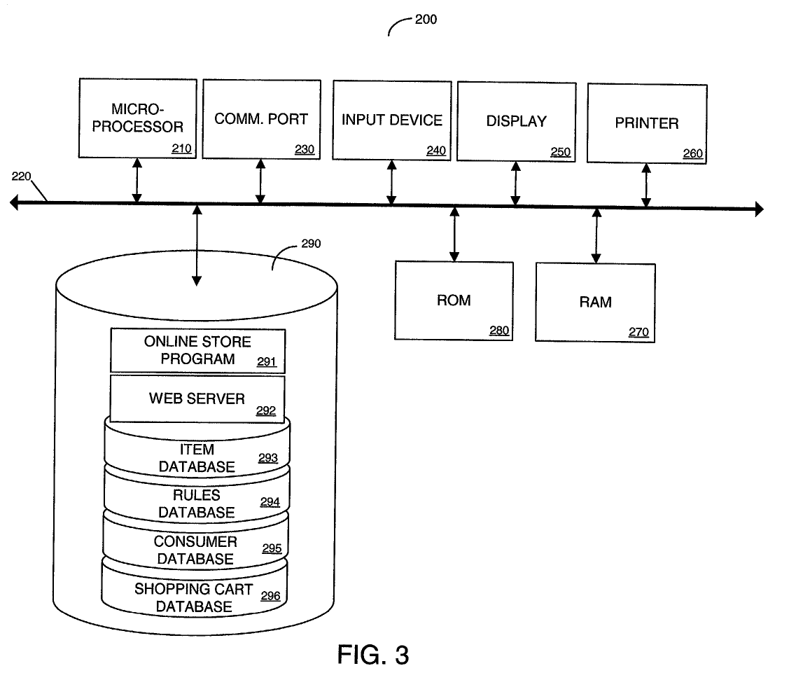

Store server 200 may comprise a Web server, local area network server or other device capable of performing steps according to the present invention. According to some embodiments, store server 200 operates to receive an instruction to associate an item with an electronic shopping cart, and, in response to the instruction, to determine that the item is not allowed to be associated with the electronic shopping cart. Store server 200 may also control various operations of an entity providing an online store, such as billing, accounting, sales tracking and the like. It should be noted that store server 200 may also perform functions unrelated to an online store. Details of one embodiment of store server 200 are set forth below with respect to FIG. 3.

Consumer devices 300 to 302 of FIG. 2 comprise a desktop computer, a personal digital assistant (PDA) and a cellular telephone. Any one of consumer devices 300 to 302 may be used by a consumer to issue an instruction to associate an item with a shopping cart, and to receive an indication that the item is not allowed to be associated with the shopping cart. Accordingly, a consumer device according to the invention may comprise any device or devices for transmitting electronic data over communication network 100. Of course, consumer devices 300 to 302 may also be used by a consumer for other functions, such as word processing, scheduling, e-mail, telephone communication, or the like.

Control device 400 may provide information based on which store server 200 determines whether an item is allowed to be associated with an electronic shopping cart. This information may include rules, consumer profiles, or item information. Detailed examples of the information and of the determination are set forth below. Control device 400 may be operated by any entity that wishes to control the items that a consumer is allowed to associate with her shopping cart. For example, control device 400 may be operated by a spouse of the consumer, a parent of the consumer, a law enforcement agency, a government entity, a legal guardian, an account holder, a credit card account holder, a co-signer on a credit card, a service bureau, a credit card company, a designated third party, a merchant, and an intelligent software agent.

It should be noted that the elements of FIG. 2 may be connected differently than as shown. For example, some or all of the elements may be connected directly to one another. Of course, embodiments of the invention may include elements that are different from those shown. Moreover, although the illustrated communication links between the components of FIG. 2 appear dedicated, it should be noted that each of the links may be shared by other components. Additionally, elements shown in communication with each other need not be constantly exchanging data. Rather, communication may be established when necessary and severed at other times or always available but rarely used to transmit data.

Store Server

FIG. 3 is a block diagram of the internal architecture of store server 200 according to one embodiment of the invention. As illustrated, store server 200 includes microprocessor 210 in communication with communication bus 220. Microprocessor 210 may be a Pentium™, RISC™, or other type of processor and is used to execute processor-executable process steps so as to control the components of store server 200 to provide functionality according to embodiments of the present invention.

Also in communication with communication bus 220 is communication port 230. Communication port 230 is used to transmit data to and to receive data from devices external to store server 200. Communication port 230 is therefore preferably configured with hardware suitable to physically interface with desired external devices and/or network connections. In one embodiment, instructions to associate items with shopping carts are received from and indications that the associations are not allowed are transmitted to consumer devices over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by an entity operating store server 200 to input item information, rules, consumer information, billing information, and other information to store server 200. Of course, such information may also be input to store server 200 via communication port 230. Commands for controlling operation of store server 200 may also be input using input device 240.

Display 250 may be an integral or separate CRT display, a flat-panel display or the like. Display 250 is generally used to output graphics and text to an operator in response to commands issued by microprocessor 210. Printer 260 may also output graphics and text, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, online store program 291 of processor-executable process steps. Microprocessor 210 executes process steps of online store program 291 in order to control store server 200 to operate an online store. For example, the process steps are executed to present items for sale to consumers, to allow consumers to select items, to receive an order for the selected items, and to receive payment in exchange for the items. Moreover, the process steps of online store program 291 may be executed by microprocessor 210 to receive an instruction to associate an item with an electronic shopping cart, and, in response to the instruction, to determine that the item is not allowed to be associated with the electronic shopping cart.

The process steps of online store program 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Process steps of Web server 292 are also stored in data storage device 290 and may be executed to provide a website to a Web client, such as a Web browser executing in consumer device 300. In order to provide a website, Hypertext Transfer Protocol (HTTP) requests are received from a Web client and, in response, appropriate Web pages are created and sent to the Web client. In the example of FIG. 3, the Web pages may be created by one or both of online store program 291 and Web browser 292.

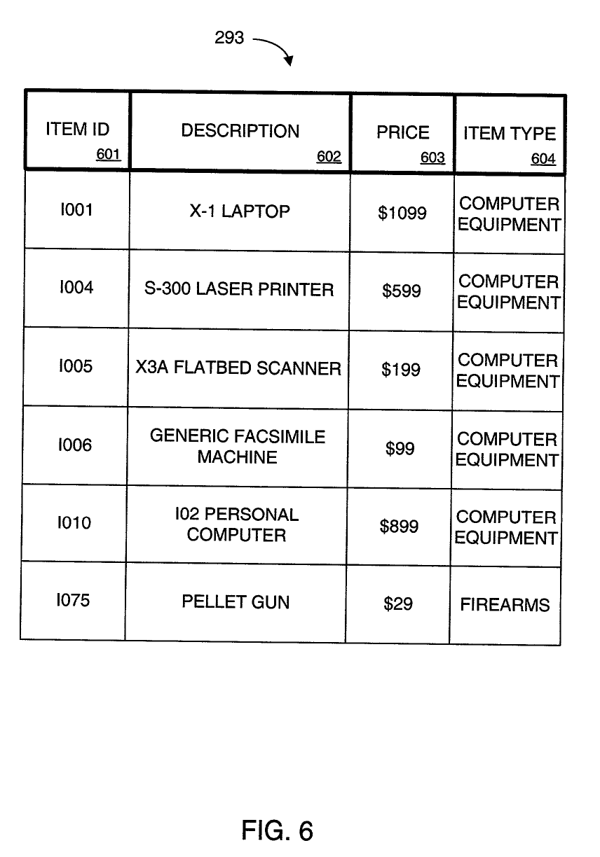

Data storage device 290 also stores item database 293, rules database 294, consumer database 295 and shopping cart database 296. Item database 293 stores information regarding items for sale. Such information may include a description, a price, or the like. One example of item database 293 is described below with respect to FIG. 6.

Rules database 294 stores rules used to determine whether an item is allowed to be associated with an electronic shopping cart. The rules may be stored in rules database 294 in association with particular consumers, with particular consumer characteristics, or with both. In other words, rules may be defined in rules database 294 as being applicable to particular consumers, to all consumers, to consumers possessing particular characteristics, or to any subset of consumers. The rules may be input by an operator of store server 200 or received from a connected device such as control device 400.

Consumer database 295 provides information regarding consumers. The information may include demographic information, purchase history, credit limit, or the like. Consumer database 295 may also include information for controlling what entities may define rules for each consumer represented therein. For example, consumer database 295 may indicate that a particular consumer's mother can define rules for determining what items are not allowed to be associated with a shopping cart associated with the consumer.

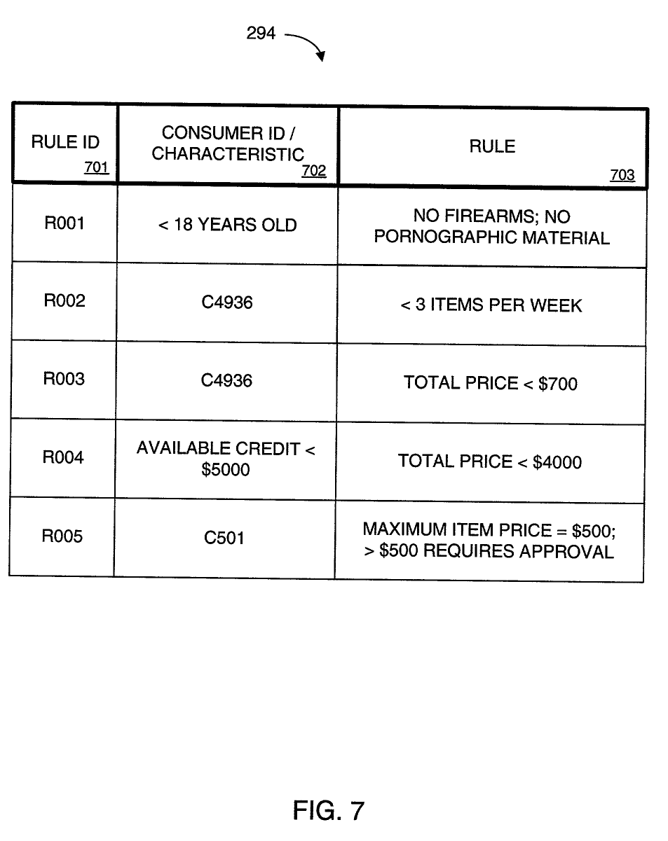

Each shopping cart managed by store server 200 is represented by a record of shopping cart database 296. Accordingly, each such record specifies items associated with its represented shopping cart, as well as information such as a total price of the items, an identity of the consumer with which the shopping cart is associated, or the like. Representative examples of rules database 294, consumer database 295 and shopping cart database 296 are shown in FIGS. 7, 8 and 9, respectively.

Stored in data storage device 290 may also be other unshown elements that may be necessary for operation of store server 200, such as other applications, other data files, a network server, an operating system, a database management system and “device drivers” for allowing microprocessor 210 to interface with devices in communication with communication port 230. These elements are known to those skilled in the art, and are therefore not described in detail herein.

Consumer Device

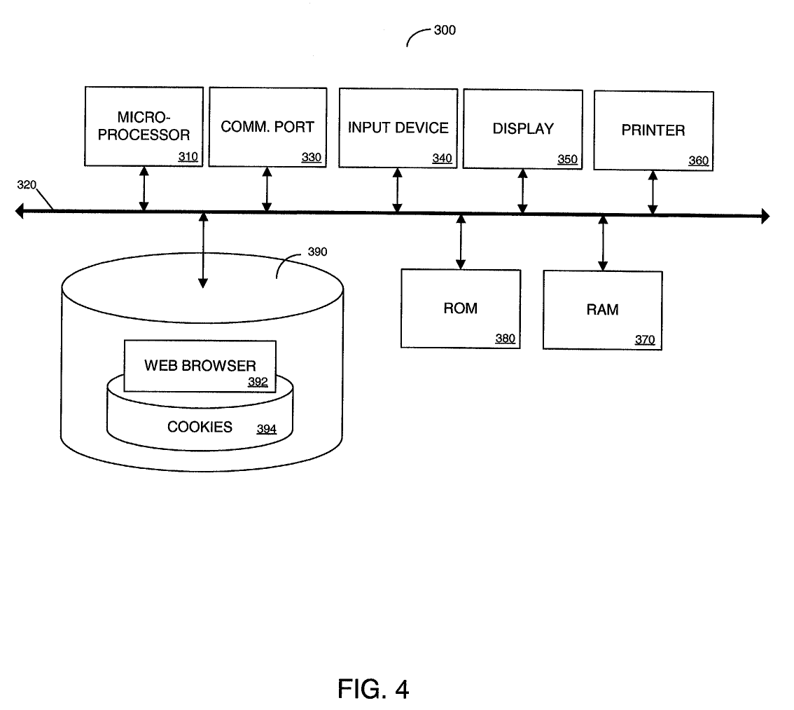

FIG. 4 illustrates several components of consumer device 300 according to embodiments of the invention. The components may comprise any of the specific examples set forth above with respect to identically-named components of store server 200. Of course, specific functions performed by the components may differ from the functions performed by the identically-named components.

In this regard, communication port 330 may be used to transmit requests for information such as Web pages and to receive the information from store server 200. Input device 340 may be used to browse received Web pages and to issue instructions to associate items with an electronic shopping cart. Display 350 may present indications that an item is not allowed to be associated with an electronic shopping cart, and printer 360 may be used to print out a purchase receipt. Input device 340, display 350 and printer 360 may also be used in conjunction with functionality provided by consumer device 300 that is unrelated to the present invention.

Data storage device 390 stores Web browser 392, which is executed by microprocessor 3 1 0 and operated by a consumer to access, browse and download information such as Web pages from Web servers supporting HTTP communication.

Also stored in data storage device 390 are cookies 396. As is known to those skilled in the art of Web browsers, a cookie is stored on a device by a Web server during a session between the device and the Web server in order to provide identification and other information to the Web server during subsequent sessions with the device. In this regard, a cookie might specify a name of a consumer operating the device, demographic information relating to the consumer, a consumer profile, a list of items purchased by the consumer, etc. Cookies stored among cookies 396 may be used in accordance with the present invention to determine whether an item is allowed to be associated with an electronic shopping cart. Such a determination will be described below.

Data storage device 390 may also store application files, data files and system files other than those shown in FIG. 4. These files may be used by consumer device 300 to provide various functionalities to a consumer in addition to those provided by the present invention.

Control Device

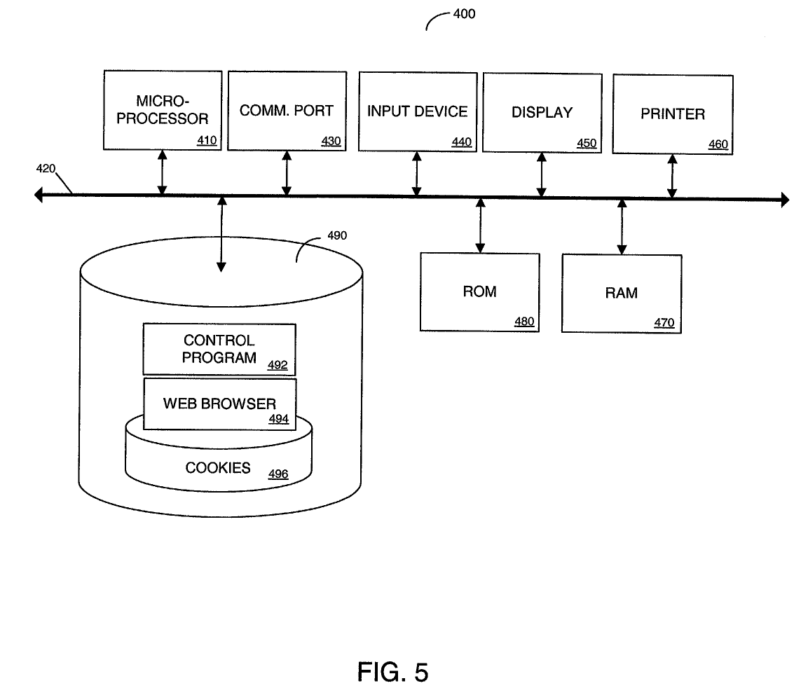

Various components of control device 400 are illustrated in FIG. 5. As mentioned with respect to FIG. 4, the components may comprise any of the specific examples set forth above with respect to identically-named components of store server 200. Again, specific functions performed by the components may differ from the functions performed by the identically-named components.

More specifically, communication port 430 may be used to transmit rules for determining whether an item is allowed to be associated with an electronic shopping cart to store server 200. The rules may be input using input device 440, and an interface for submitting the rules may be presented to an operator by display 450. Each of input device 440, display 450 and printer 460 may also be used with applications executed by control device 400 that are unrelated to the present invention.

Data storage device 490 stores processor-executable process steps of control program 492. The process steps may be received from any of the aforementioned media and executed by microprocessor 410 to present the above-mentioned interface for submitting rules, to submit rules and associated control codes, and to receive and present notifications to an operator. The notifications may be received from store server 200 and may indicate that an instruction was received to associate an item with an electronic shopping cart and/or that it was determined that an item was not allowed to be associated with an electronic shopping cart. Such notifications allow an operator of control device 400 to monitor the enforcement of submitted rules.

Web browser 494 is executed by microprocessor 410 and used to access, browse and download information such as Web pages from Web servers supporting HTTP communication. Web browser 494 may be used in conjunction with control program 492 in a case that store server 200 and control device 400 communicate using HTTP. Web browser 494 may, of course, also be used by an operator of control device 400 to browse the World Wide Web for purposes unrelated to the present invention.

Cookies 496 are also stored in data storage device 490. Cookies 496 may include information identifying the operator of control device 400 and/or control codes used to submit rules to store server 200. Accordingly, the operator might not be required to submit such information when submitting rules, thereby simplifying the submission.

It should be noted that data storage device 490 may also store other files used by control device 400 to provide functions in addition to those provided by embodiments of the present invention.

Item Database

A tabular representation of a portion of item database 293 is shown in FIG. 6. The information stored in item database 293 may be entered by an operator of store server 200 through input device 240 or may be received from another device such as control device 400 over communication network 100. The stored information provides details regarding items offered for sale by an online store according to the present invention.

Item database 293 includes several records and associated fields. The fields include item ID field 601, description field 602, price field 603, and item type field 604. Item ID field 601 of a record represents an item associated with the record that is offered for sale by store server 200, and provides a shorthand notation for referring to the item. Description field 602 provides a description of an item that may be presented to a consumer so that the consumer may identify the item, and price field 603 specifies the retail price of an associated item. Item type field 604 specifies one or more categories to which an associated item belongs. The categories, as well as the prices and descriptions specified in item database 294, may be used to determine that an item is not allowed to be associated with an electronic shopping cart. In one example, a rule associated with a consumer may indicate that the consumer may not purchase firearms. Accordingly, if the consumer issues an instruction to add item “I075” to her shopping cart, it is determined based on item type field 604 that the item is not allowed to be associated with the consumer's shopping cart.

Of course, item database 293 may include information in addition to or instead of that shown in FIG. 6. For example, item database 293 may include a path to a photograph of an item, nutritional information, warranty information, manufacturer information, or the like. Moreover, an item represented in item database may comprise any type of good and/or service, including merchandise, stocks, bonds, promises, and knowledge.

Rules Database

A tabular representation of a portion of rules database 294 is shown in FIG. 7. As mentioned above, rules database 294 may store rules used to determine that an item is not allowed to be associated with an electronic shopping cart. The rules may be generated by store server 200 or received from an external entity, such as control device 400.

Each record of rules database 294 includes rule ID field 701, consumer ID/characteristic field 702, and rule field 703. Rule ID field 701 of a record includes an identifier specifying a rule associated with the record. The identifier may be assigned to the rule by store server 200 when the rule is stored in rule database 294, or may be transmitted by the entity from which the rule is received.

Consumer ID/characteristic field 702 of a record specifies a consumer and/or a characteristic which is used to determine whether a rule associated with the record is applicable to a particular consumer. For example, the rule is applicable if the particular consumer is associated with a specified consumer ID in consumer database 295 and/or possesses a specified characteristic. Whether or not the consumer possesses the specified characteristic may be determined based on cookies 394, information associated with the consumer in consumer database 295, a survey, and/or other sources.

Rule field 703 includes rules used to determine that an item is not allowed to be associated with an electronic shopping cart. As shown in FIG. 7, the rules may be based at least in part on an item type, a number of items per time period, a total price, and a price of one item. The rules may also be based on a multitude of other factors, including but not limited to time periods, other items associated with the electronic shopping cart, a consumer profile, consumer characteristics, a profile of an entity responsible for a consumer, consumer demographic information, a consumer rating, financial status of a consumer, preferences of an entity responsible for a consumer, nutritional and health properties of items, prior purchase history.

More than one rule may be specified in rule field 703 of a record, and a rule may be conditional. For example, a rule may specify scenarios in which approval is required before associating an item with an electronic shopping cart. Rules may also be fuzzy, statistical, stochastic and aggregates of other rules. The rules may also be dynamically modified based on tracked information located in a local or remote database.

The rules stored in rules database 294 may be input by an operator of store server 200 or may be received from other devices. More specifically, rules may be defined by entities such as a spouse of the consumer, a parent of the consumer, a law enforcement agency, a government entity, a legal guardian, an account holder, a credit card account holder, a co-signer on a credit card, a service bureau, a credit card company, a designated third party, a merchant, and an intelligent software agent. In this regard, a rule may also specify that a particular entity should be notified, in certain instances, once an instruction is received to associate an item with a electronic shopping cart.

Consumer Database

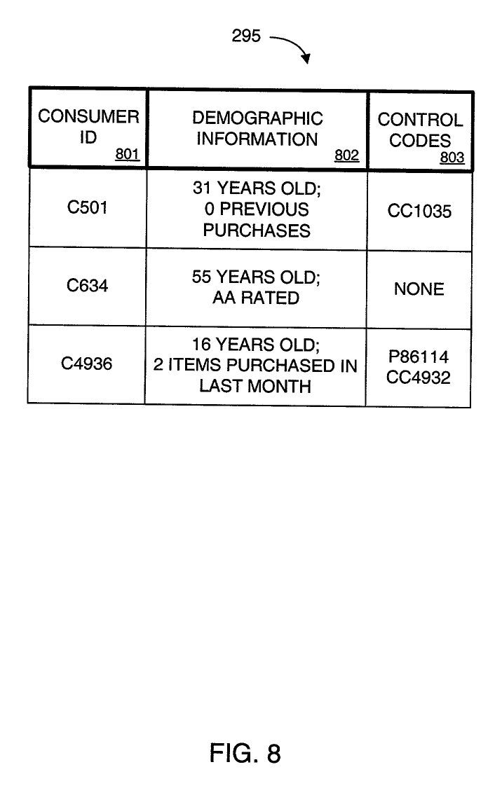

Consumer database 295 of FIG. 8 includes information regarding consumers. More particularly, consumer ID field 801, consumer information field 802 and control codes field 803 of the illustrated records include information relating to consumers who may issue instructions to add items to electronic shopping carts. Accordingly, the information may be used to determine that the items are not allowed to be associated with the electronic shopping carts. The information stored in consumer database 295 may be received from cookies 394, directly from consumers through a survey or registration process, or from entities providing consumer information.

With respect to the specific fields, consumer ID field 801 of a record includes an identifier of a consumer who is the subject of the record. Consumer information field 802 specifies any type of consumer information, such as demographic information, preferences, characteristics, a profile, etc. Accordingly, the information stored in consumer ID field 801 and consumer information field 802 may be used in conjunction with the information stored in consumer ID/characteristic field 702 to determine if a rule applies to a consumer.

Control codes field 803 of a record lists codes and/or identifiers used to associate rules with a consumer. For example, some embodiments allow an entity to associate a rule with a consumer in rules database 294 only if that entity can provide a control code that is associated with the consumer in control codes field 803. In some embodiments, control codes field 803 specifies an identifier of an entity that may associate a rule with a consumer. Accordingly, if an entity attempts to associate a rule with a consumer, store server 200 may allow the association only if the entity corresponds to an identifier associated with the consumer in control codes field 803. Cookies 496 may be used to determine if the entity corresponds to the identifier.

Control codes field 803 may also be used to determine from what entity a necessary approval should be obtained. As mentioned above, a rule of rules database 394 may require approval to allow an item to be associated with an electronic shopping cart. The rule itself may specify from whom the approval must be received, and/or control codes field 803 may identify an entity capable of providing appropriate approval. Examples of such entities include a parent of the consumer, a law enforcement agency, a government entity, a legal guardian, an account holder, a credit card account holder, a co-signer on a credit card, a service bureau, a credit card company, a designated third party, a merchant, and an intelligent software agent.

Shopping Cart Database

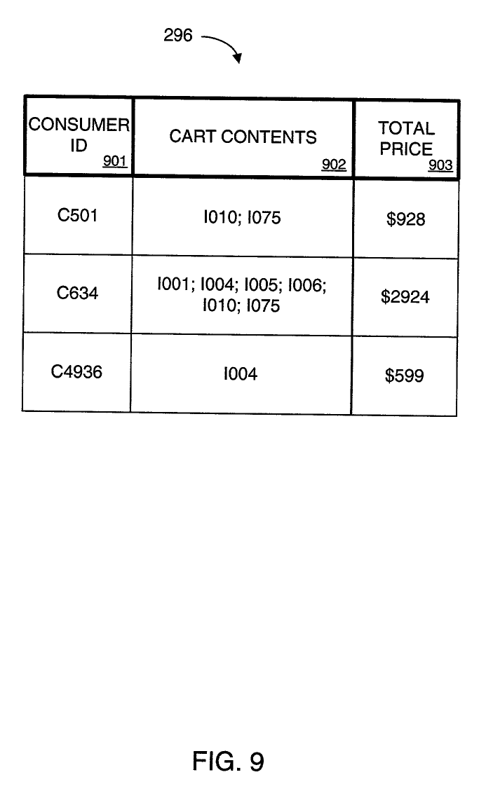

FIG. 9 shows a tabular representation of a portion of shopping cart database 296 according to some embodiments of the present invention. Shopping cart database 296 includes information usable to track items associated with electronic shopping carts provided by store server 200.

Specifically, each record in shopping cart database 296 includes consumer ID field 901, cart contents field 902, and total price field 903. Accordingly, each record represents a distinct electronic shopping cart. A record of shopping cart database 296 may be created for a consumer once the consumer logs on to an online store, once the consumer chooses to associate an item or items with an electronic shopping cart, or at any other appropriate time.

Consumer ID field 901 of a record includes an identifier specifying a consumer with whom the record is associated. The identifier may therefore also be used to identify a shopping cart associated with the consumer. Cart contents field 902 includes identifiers specifying items associated with the shopping cart. An identifier may be stored in cart contents field 902 in response to an instruction from a consumer to associate an item with an electronic shopping cart. In some embodiments, an identifier is stored only after it is determined that an associated item is allowed to be associated with the subject electronic shopping cart. Also, a system according to the invention may provide a duplication feature allowing a consumer to associate items from a first shopping cart with a second shopping cart. In such a case, identifiers of items associated with the first shopping cart are stored in cart contents field 902 of the second shopping cart.

Total price field 903 specifies a total price to be charged to a consumer for all items associated with an associated shopping cart. The total price may be a sum of the retail prices of all items specified in associated cart contents field 902, or may reflect a discount or premium applied to the sum of retail prices.

It is contemplated that each of item database 293, rules database 294, consumer database 295 and shopping cart database 296 may include many more records than those shown and that each record may include associated fields other than those illustrated. It should also be noted that the tabular illustrations and accompanying descriptions of the databases merely represent relationships between stored information. A number of other arrangements may be employed besides those suggested.

Specific Example

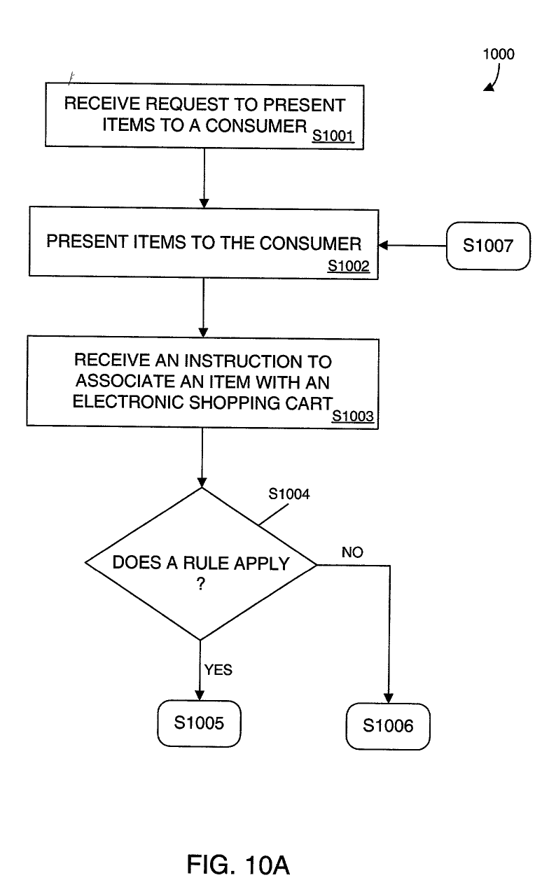

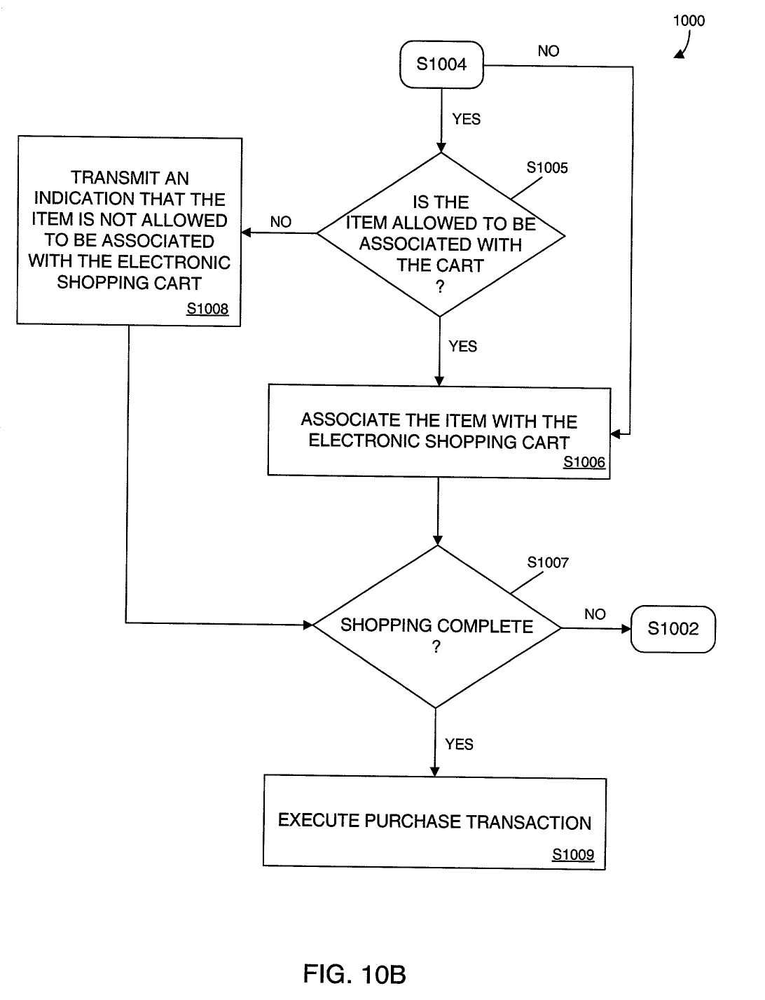

Process steps 1000 of FIGS. 10A and 10B set forth an electronic shopping process according to some embodiments of the present invention. Process steps 1000 are described below as if included in online store program 291 and executed by microprocessor 210 of store server 200. Of course, it should be noted that process steps 1000 may be performed by any device or by any number of devices in combination, including consumer device 300 and control device 400. Moreover, some or all of process steps 1000 may be performed manually.

Process steps 1000 begin at step S1001 , in which a request is received to present items to a consumer. In some embodiments, the request is transmitted by Web browser 392 executing in consumer device 300. More specifically, a consumer uses input device 340 to input a Uniform Resource Locator (URL) into a window displayed on display 350 by Web browser 392. In response, an IP address corresponding to the URL is retrieved from a Domain Name Server and a request is sent via HTTP to the IP address. According to this example, the IP address corresponds to store server 200, therefore the request is received in step S1001 by store server 200.

In the online store embodiment, the request may be received in step S1001 while a consumer operates Web browser 394 to browse Web pages of the online store. Accordingly, the request may request access of a specific Web page of the online store. For example, the request may comprise a selection of a hyperlink to a Web page presenting computing-related items.

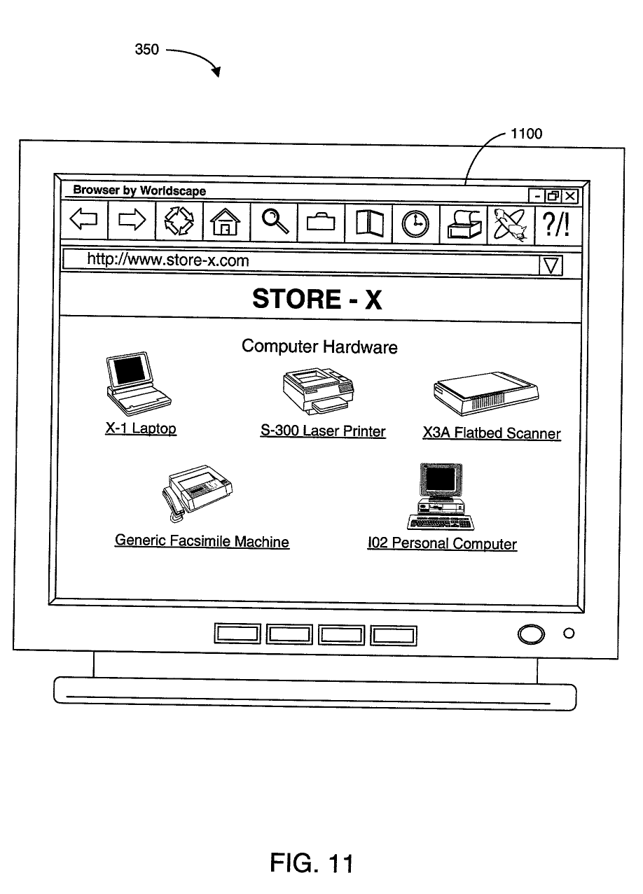

In response to the request, items are presented to the consumer in step S1002. In a particular example of step S1002, Web server 292 of server 200 creates an HTML page presenting the items in conjunction with online store program 291 and transmits the page to consumer device 300. FIG. 11 is a representative view of display 350 presenting such a page. As shown, page 1100 presents images of several items along with explanatory text.

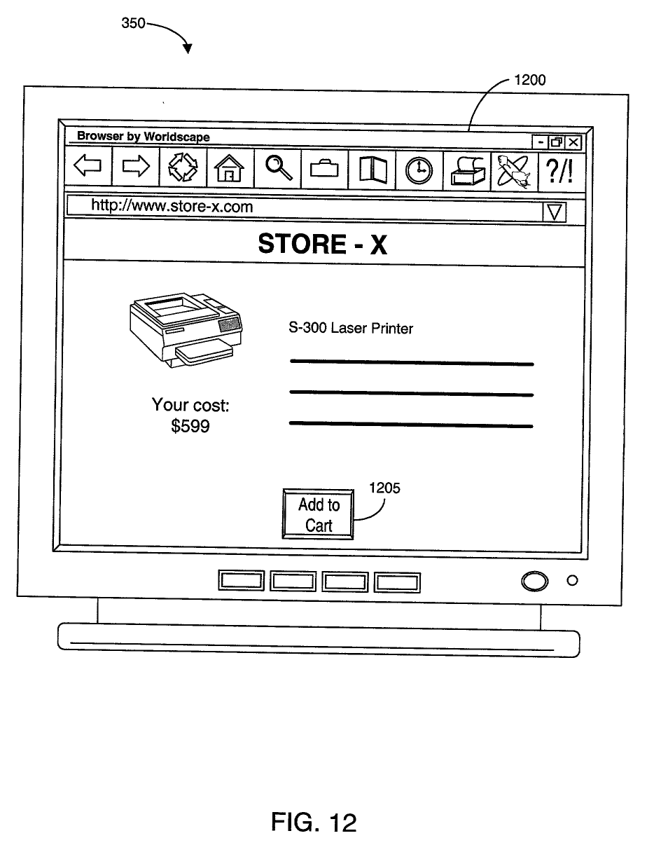

The consumer may select one of the presented items using input device 340, in response to which store server 200 creates and transmits an item detail page to consumer device 300. Item detail page 1200 of FIG. 12 is an example of an item detail page presented to the consumer upon selection of the “S-300 Laser Printer” from page 1100. Item detail page 1200 presents an image of the selected item and text in addition to the explanatory text displayed in page 1100. The image and the text may be retrieved from a record of item database 293 associated with the selected item.

Also included in item detail page 1200 is “Add to Cart” icon 1205. According to this example, “Add to Cart” icon 1205 is selected by the consumer to issue an instruction to associate the selected item with an electronic shopping cart associated with the consumer. The instruction is received in step S1003.

After the instruction is received, it is determined in step S1004 whether a rule applies to the current scenario. In the present example, store server 200 retrieves a cookie from cookies 394 that provides an identifier corresponding to the consumer operating consumer device 300. The retrieved cookie indicates that the consumer corresponds to consumer ID “C4936”. The consumer ID is compared against entries in consumer ID/characteristic field 702 of rules database 294 to identify rules “R002” and “R003” as corresponding to the consumer and therefore applying to the current scenario.

Because the applicability of rules may also be based on consumer characteristics, the retrieved consumer ID is also used to locate a record of consumer database 295 that includes information relating to the consumer. According to the present example, information from consumer information field 802 corresponding to consumer “C4936” is retrieved and compared with information specified in consumer ID/characteristic field 702 of rules database 294. As a result, rule “R001” is also identified as being applicable to the present scenario.

Using the rules identified in step S1004, it is determined in step S1005 whether the selected item is allowed to be associated with the cart. The selected item does not violate rule “R001”, because the item is neither firearms nor pornographic. In order to determine if the selected item violates rule “R001”, the item type is retrieved from associated item type field from item database 293. Since neither of rules “R002” or “R003” are violated, it is determined in step S1005 that the item is allowed to be associated with the electronic shopping cart. Accordingly, in step S1006, the item is associated with the electronic shopping cart.

In a case that an applicable rule requires approval from a third party before the item is associated with the shopping cart, the approval may be sought in step S1005. Approval may be item-dependent, therefore approval may be required only for a subset of items associated with a particular shopping cart. Whether or not approval is required, an applicable rule may specify that a third party be notified of receipt of the instruction in step S1003. Such notification may also occur in step S1005.

In order to associate the item with the electronic shopping cart, a record associated with the consumer is created in shopping cart database 296. More specifically, a record is created (if not previously created) in which consumer ID field 901 includes the consumer ID associated with the consumer, and in which an identifier representing the selected item populates cart contents field 902. FIG. 9 shows such a record after association of the selected item in step S1006.

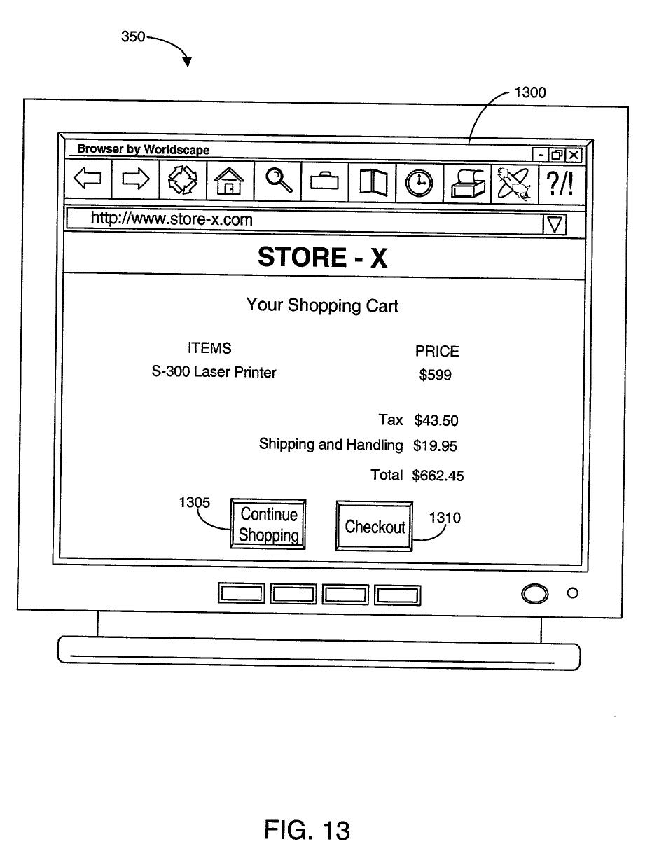

After the item is associated with the electronic shopping cart, store server 200 may generate and transmit a Web page illustrating the contents of the shopping cart. Such a process may be automatically performed after step S1006, or may be in response to a request from the consumer to view the contents of the cart. Web page 1300 of FIG. 13 is an example of a Web page illustrating the contents of a shopping cart. Accordingly, Web page 1300 includes, for each item associated with the shopping cart in shopping cart database 296, a description and a price associated with the item in item database 293. Web page 1300 also includes other information such as tax, shipping and handling charges, and a total price for items associated with the shopping cart.

Next, in step S1007, it is determined whether the consumer is finished shopping. This determination is based on whether the consumer selects “continue shopping” icon 1305 or “checkout” icon 1310 of Web page 1300. If “continue shopping” icon 1305 is selected, it is determined that the consumer is not finished shopping and flow returns to step S1002 and proceeds as described above.

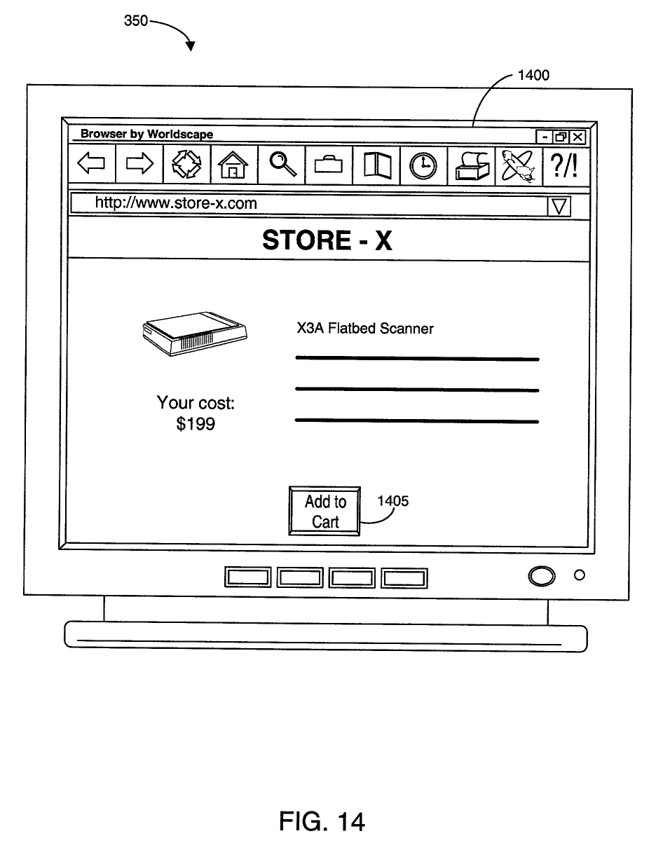

In this regard, it is assumed that Web page 1100 is again presented to the consumer in step S1002, and the consumer selects the item “X3A Flatbed Scanner”. Accordingly, Web page 1400 of FIG. 14 is presented to the consumer. Upon selection of icon 1405, an instruction is received in step S1003 to associate the selected item with the consumer's electronic shopping cart. For the same reasons as described above, it is determined in step S1004 that a rule applies to the current scenario (rules “R001”, “R002” and “R003”) and flow continues to step S1005.

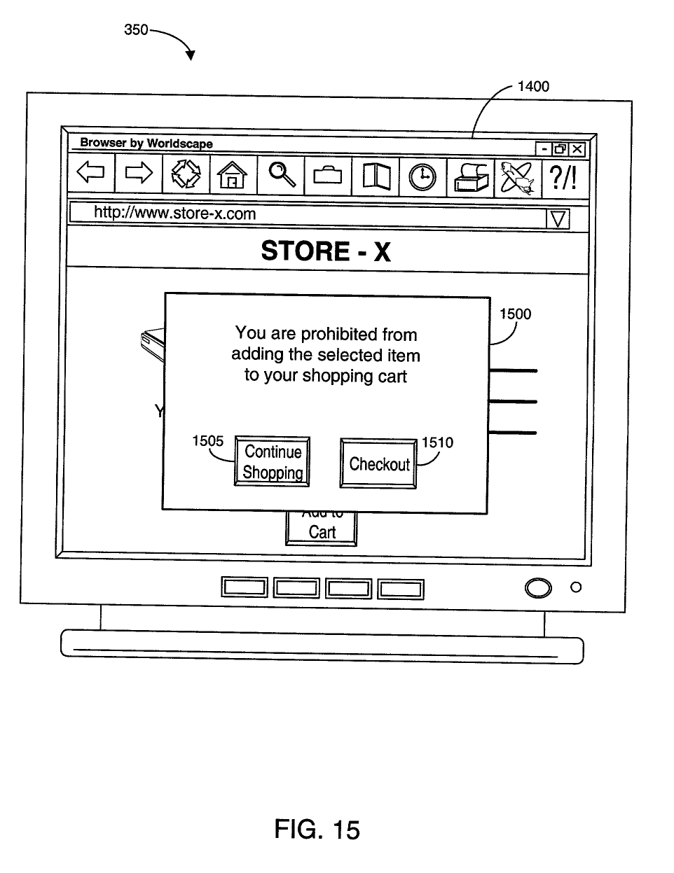

At step S1005, it is determined that association of the selected item with the electronic shopping cart would violate rule “R003”. Specifically, the total price of all items associated with the cart would be greater than $700. As a result, an indication is transmitted in step S1008 that the selected item is not allowed to be associated with the electronic shopping cart. FIG. 15 shows display 350 after transmission of such an indication from store server 200 to customer device 300.

Window 1500 includes “continue shopping” icon 1505 and “checkout” icon 1510. As described above, a consumer selection of one of icons 1505 and 1510 is used in step S1007 to determine whether the consumer has finished shopping. If “checkout” icon 1510 is selected, it is determined that the consumer has finished shopping and flow proceeds to step S1009, wherein a purchase transaction is executed to sell each item associated with the electronic shopping cart to the consumer.

In some embodiments of the invention, a consumer may issue an instruction to disassociate an item from a shopping cart. In such a case, an identifier representing the item is removed from a record of shopping cart database 296 corresponding to the shopping cart. However, rules database 295 may define rules prohibiting disassociation of an item from a shopping cart in some instances. If such an instance exists, an indication may be transmitted to the consumer that the item is not allowed to be disassociated with the shopping cart.

According to some embodiments, a presented electronic shopping cart may include a representation of an item selected by a consumer but not allowed to be associated with the electronic shopping cart. The representation may indicate that the item is not allowed to be associated with the shopping cart by visual, auditory, olfactory or tactile means. For example, the representation may be blinking, grayed-out or colored red. In some embodiments, the representation indicates that a required approval for the item has not yet been received. Accordingly, after approval is received, the representation may change so as to no longer indicate that the item is not allowed to be associated with the shopping cart.

Although the present invention has been described with respect to particular embodiments thereof, those skilled in the art will note that various substitutions may be made to those embodiments described herein without departing from the spirit and scope of the present invention.

What is claimed is:

1. A method for electronic shopping, comprising:
receiving an instruction to associate an item with an electronic shopping cart; and
in response to the instruction, determining that the item is not allowed to be associated with the electronic shopping cart.

2. A method according to claim 1, wherein the determination is based on rules.

3. A method according to claim 2, wherein the instruction is received from a consumer, and wherein the rules are defined at least in part by at least one of: a spouse of the consumer; a parent of the consumer; a law enforcement agency; a government entity; a legal guardian; an account holder; a credit card account holder; a co-signer on a credit card; a service bureau; a credit card company; a designated third party; a merchant; and an intelligent software agent.

4. A method according to claim 2, wherein the rules are based at least in part on a price of the item.

5. A method according to claim 4, wherein the rules comprise a rule specifying that a price of all items in the shopping cart may not exceed a specified total price.

6. A method according to claim 4, wherein the rules comprise a rule specifying that a price of any one item in the shopping cart may not exceed a specified price.

7. A method according to claim 2, wherein the rules are based at least in part on a type of the item.

8. A method according to claim 2, wherein the rules are based at least in part on a number of items in the shopping cart.

9. A method according to claim 2, wherein the rules are based at least in part on whether other particular items are associated with the shopping cart.

10. A method according to claim 2, wherein the rules require approval from at least one entity.

11. A method according to claim 2, wherein the rules are based at least in part on one of: the item; a profile of a consumer from whom the instruction was received; and a profile of an entity responsible for the consumer.

12. A method according to claim 2, wherein the rules are based at least in part on a financial status of a consumer from whom the instruction was received.

13. A method according to claim 2, wherein the rules are based at least in part on a demographic of a consumer from whom the instruction was received.

14. A method according to claim 2, wherein the rules are based at least in part on a rating of a consumer from whom the instruction was received.

15. A method according to claim 2, wherein the rules are based at least in part on preferences of an entity responsible for a consumer from whom the instruction was received.

16. A method according to claim 2, wherein the rules are at least one of: fuzzy; conditional; time-dependent; statistical; stochastic; and based on an aggregate of other rules associated with one or more consumers.

17. A method according to claim 2, wherein the rules are based at least in part on nutritional and health properties of the item.

18. A method according to claim 2, wherein the rules are based at least in part on prior purchases.

19. A method according to claim 2, wherein the rules are dynamically modified based on information from an external database.

20. A method according to claim 1, wherein the instruction is received from a consumer, and wherein the determining step comprises:
determining whether approval of the association has been received from at least one of: a spouse of the consumer, a parent of the consumer; a law enforcement agency; a government entity; a legal guardian; an account holder; a credit card account holder; a co-signer on a credit card; a service bureau; a credit card company; a designated third party; a merchant; and an intelligent software agent.

21. A method according to claim 20, wherein the step of determining whether approval of the association has been received is not performed for all items.

22. A method according to claim 1, further comprising:
notifying an entity of receipt of the instruction.

23. A method according to claim 22, wherein the entity is a service bureau.

24. A method according to claim 22, wherein the entity is at least one of: a spouse of the consumer, a parent of the consumer; a law enforcement agency; a government entity; a legal guardian; an account holder; a credit card account holder; a co-signer on a credit card; a service bureau; a credit card company; a designated third party; a merchant; and an intelligent software agent.

25. A method according to claim 1, further comprising:
presenting a second item for associating with the electronic shopping cart.

26. A method according to claim 1, further comprising:
in response to the instruction, associating a second item with the electronic shopping cart.

27. A method according to claim 1, further comprising:
receiving an instruction to disassociate a second item from the shopping cart; and
indicating that the second item is not allowed to be disassociated from the shopping cart.

28. A method according to claim 1, further comprising:
associating items associated with the electronic shopping cart with a second electronic shopping cart.

29. A method according to claim 1, wherein the item comprises at least one of: merchandise; stocks; bonds; services; promises; and knowledge.

30. A method according to claim 1, further comprising:
indicating that the item is not allowed to be associated with the electronic shopping cart.

31. A method according to claim 1, further comprising:
presenting the electronic shopping cart including a representation of the item, the representation indicating that the item is not allowed to be associated with the electronic shopping cart.

32. A method according to claim 1, further comprising:
presenting the electronic shopping cart including a representation of the item, the representation indicating that approval for the item is pending.

33. A method according to claim 32, further comprising:
receiving approval for the item; and
presenting the electronic shopping cart including a second representation of the item, the second representation indicating that the item is allowed to be associated with the electronic shopping cart.

34. A method for electronic shopping, comprising:
issuing an instruction to associate an item with an electronic shopping cart; and
in response to the instruction, receiving an indication that the item is not allowed to be associated with the electronic shopping cart.

35. A medium storing processor-executable process steps, the process steps comprising:
a step to receive an instruction to associate an item with an electronic shopping cart; and
in response to the instruction, a step to determine that the item is not allowed to be associated with the electronic shopping cart.

36. A medium according to claim 35, wherein the determination is based on rules.

37. A medium according to claim 36, wherein the instruction is received from a consumer, and wherein the rules are defined at least in part by at least one of: a spouse of the consumer; a parent of the consumer; a law enforcement agency; a government entity; a legal guardian; an account holder; a credit card account holder; a co-signer on a credit card; a service bureau; a credit card company; a designated third party; a merchant; and an intelligent software agent.

38. A medium according to claim 36, wherein the rules are based at least in part on a price of the item.

39. A medium according to claim 38, wherein the rules comprise a rule specifying that a price of all items in the shopping cart may not exceed a specified total price.

40. A medium according to claim 38, wherein the rules comprise a rule specifying that a price of any one item in the shopping cart may not exceed a specified price.

41. A medium according to claim 36, wherein the rules are based at least in part on a type of the item.

42. A medium according to claim 36, wherein the rules are based at least in part on a number of items in the shopping cart.

43. A medium according to claim 36, wherein the rules are based at least in part on whether other particular items are associated with the shopping cart.

44. A medium according to claim 36, wherein the rules require approval from at least one entity.

45. A medium according to claim 36, wherein the rules are based at least in part on one of: the item; a profile of a consumer from whom the instruction was received; and a profile of an entity responsible for the consumer.

46. A medium according to claim 36, wherein the rules are based at least in part on a financial status of a consumer from whom the instruction was received.

47. A medium according to claim 36, wherein the rules are based at least in part on a demographic of a consumer from whom the instruction was received.

48. A medium according to claim 36, wherein the rules are based at least in part on a rating of a consumer from whom the instruction was received.

49. A medium according to claim 36, wherein the rules are based at least in part on preferences of an entity responsible for a consumer from whom the instruction was received.

50. A medium according to claim 36, wherein the rules are at least one of: fuzzy; conditional; time-dependent; statistical; stochastic; and based on an aggregate of other rules associated with one or more consumers.

51. A medium according to claim 36, wherein the rules are based at least in part on nutritional and health properties of the item.

52. A medium according to claim 36, wherein the rules are based at least in part on prior purchases.

53. A medium according to claim 36, wherein the rules are dynamically modified based on information from an external database.

54. A medium according to claim 35, the process steps further comprising:
a step to present the electronic shopping cart including a representation of the item, the representation indicating that the item is not allowed to be associated with the electronic shopping cart.

55. A medium according to claim 35, the process steps further comprising:
a step to present the electronic shopping cart including a representation of the item, the representation indicating that approval for the item is pending.

56. A medium according to claim 55, the process steps further comprising:
a step to receive approval for the item; and
a step to present the electronic shopping cart including a second representation of the item, the second representation indicating that the item is allowed to be associated with the electronic shopping cart.

57. A medium storing processor-executable process steps, the process steps comprising:
a step to issue an instruction to associate an item with an electronic shopping cart; and
in response to the instruction, a step to receive an indication that the item is not allowed to be associated with the electronic shopping cart.

58. An apparatus for electronic shopping, comprising:
a processor; and
a storage device in communication with the processor and storing instructions adapted to be executed by the processor to:
receive an instruction to associate an item with an electronic shopping cart; and
in response to the instruction, determine that the item is not allowed to be associated with the electronic shopping cart.

59. An apparatus for electronic shopping, comprising:
a processor; and
a storage device in communication with the processor and storing instructions adapted to be executed by the processor to:
issue an instruction to associate an item with an electronic shopping cart; and in response to the instruction, receive an indication that the item is not allowed to be associated with the electronic shopping cart.
